(19) United States
(12) Patent Application Publication
(10) Pub. No.: US 2007/0221863 A1
(43) Pub. Date: Sep. 27, 2007

(54) Emission detector for the remote detection of explosives and illegal drugs

(76) Inventor: Edward C. Zipf, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/637,200

(22) Filed: Dec. 11, 2006

Related U.S. Application Data
(60) Provisional application No. 60/749,811, filed on Dec. 12, 2005.

(51) Int. Cl. G01N 21/64

(52) U.S. Cl. 250/461.1

(57) ABSTRACT

An emission detector for detecting explosives or illegal drugs is disclosed. The emission detector is portable, non-invasive, and easily hidden. The emission detector includes an illumination module, including a light source for outputting a flash of ultraviolet light having a wavelength of from 190 nm to 350 nm, the output flash illuminating an out-gassing material; and a detector module, optically aligned with the illumination module, the detector module including a molecular filter that is optically matched to the ground state absorption of ambient gas molecules, the molecular filter having an output, and a photomultiplier optically coupled to the output of the molecular filter for detecting a secondary fluorescent signature from the out-gassing material. The out-gassing material can be an explosive or an illegal drug. The ambient gas molecules can be at least one of NO, CH, OH, CHO, CH₂O, C₂H or NO₂. The detector can further include a second illumination module which can have an intensity matched to the intensity of the first illumination module, or can be optically coupled to ambient gas molecules. The emission detector can be housed fully, or at least partially, on a drone or robot which can be remotely controlled.

### CROSS REFERENCE TO RELATED APPLICATION

This application claims priority to U.S. Provisional Patent Application 60/749,811, filed Dec. 12, 2005, the entire content of which is herein incorporated by reference in its entirety.

### BACKGROUND OF THE INVENTION

1. Field of the Invention

The present invention relates generally to detection devices and, more particularly, to an emission detector for remotely detecting the secondary fluorescent signature of an explosive or illegal drug.

2. Description of Related Art

Recent terrorist events have caused an increasing need to monitor and detect explosive threats. Events, transportation systems, and buildings are all, unfortunately, the potential target of an attack. Previous detection efforts have typically required manual inspection, or the installation of substantial detection systems. Manual detection is costly and highly intrusive, typically requiring multiple people to carry detectors into high risk areas to monitor for explosive agents and devices. Furthermore, it is not usually feasible to fully protect a large area over an extended period due to staffing limitations, thereby exposing the possibility of a breach of security within an area.

Permanently installed detection systems offer the benefit of being less noticeable within a high risk area. However, they typically require a supporting power supply and can be more easily avoided by terrorists. In addition, permanent installations are expensive and usually cost-prohibitive for most areas. Shipping and air cargo facilities, truck trailers, airports, subways, tunnels, sports arenas, schools, banks, and other high traffic venues would all benefit from portable hidden explosive detection devices.

The detection of illegal drugs and other substances is also of great interest in reducing crime and improving security. Again, most detection efforts typically require manual inspection and are costly and time consuming. Permanently installed detection systems are typically too cost-prohibitive for most settings. There are numerous applications, including finding illegal drug manufacturing facilities, securing border crossings, airports and cargo transport mechanisms, that would benefit from a portable hidden detector of illegal drugs that is cost-effective, portable, and non-intrusive.

A portable hidden detection device of explosives and/or illegal drugs would also greatly benefit policemen and SWAT teams by allowing detection of loaded weapons in routine car stops and/or complex SWAT engagements. A portable hidden detection device would also greatly benefit the detection of aliens carrying drugs or terrorists carrying bomb materials across borders as part of a comprehensive border inspection/immigration program.

Accordingly, a need remains for a portable hidden detection device capable of detecting explosives and/or illegal drugs in a cost-effective, non-intrusive manner.

### SUMMARY OF THE INVENTION

A portable and easily hidden emission detector of the present invention is capable of detecting a variety of bomb, firearm and drug threats. In one non-limiting embodiment, the emission detector identifies the optical signature of the bomb, firearm or illegal drug by photodissociating the plume vapors in the air, and detecting the resulting electronic bands by, for example but not limited to, resonance fluorescence, direct photodissociative excitation, as a by-product of air photochemistry, or by stimulating a very large release of radicals from the ultraviolet (UV) catalyzed photodissociation of the residues of the explosive deposited on the soil, on the surface of a suitcase, clothing or in a vehicle that contains a car bomb. The resulting electronic bans can be for any of NO, CH, OH, CHO, CH₂O, C₂H, or NO₂. As the detection mechanism is only weakly temperature dependent, the invention can be used to detect explosives or illegal drugs in very cold weather.

An exemplary emission detector of the present invention exploits the unique out-gassing multispectral time signature of each explosive or drug, not only to discriminate against background signals but also to specifically identify the type of explosive or drug by producing a secondary fluorescent signature specific to the out-gassing material.

In a further non-limiting embodiment, an emission detector includes an illumination module, including a light source for outputting a flash of ultraviolet light having a wavelength of from 190 nanometers (nm) to 350 nm, the output flash illuminating an out-gassing material; and a detector module, optically aligned with the illumination module, the detector module including a molecular filter that is optically matched to the ground state absorption of ambient gas molecules, the molecular filter having an output, and a photomultiplier optically coupled to the output of the molecular filter for detecting a secondary fluorescent signature from the out-gassing material.

In a still further non-limiting embodiment, the present invention provides a drone including a housing; means for remotely moving the housing; and an emission detector, at least partially positioned on the housing. The emission detector includes an illumination module, including a light source for outputting a flash of ultraviolet light having a wavelength of from 190 nm to 350 nm, the output flash illuminating an out-gassing material. The device further includes a detector module, optically aligned with the illumination module, the detector module including a molecular filter that is optically matched to the ground state absorption of ambient gas molecules, the molecular filter having an output, and a photomultiplier optically coupled to the output of the molecular filter for detecting a secondary fluorescent signature from the out-gassing material.

A method of detecting an out-gassing substance in accordance with the invention includes the steps of: outputting a flash of ultraviolet light having a wavelength of from 190 nm to 350 nm to illuminate an out-gassing material; detecting molecular properties of the out-gassing material; filtering the ground-state absorption of ambient gas molecules with a molecular filter; and detecting a secondary fluorescent signature from the out-gassing material through the molecular filter.

### BRIEF DESCRIPTION OF THE DRAWINGS

FIG. 1 is a schematic representation of an emission detector having two illumination modules and a detector module in accordance with an embodiment of the present invention;

FIG. 2 is a graphical representation of the UV background spectra, plotting wavelength vs. intensity in accordance with an embodiment of the present invention;

FIG. 3 is a schematic representation of the illumination module in accordance with an embodiment of the present invention;

FIG. 4 is a graphical representation of the time signature of an FX-1155 xenon arc flash lamp having a full width half maximum (FWHM) of 125 nanoseconds in accordance with an embodiment of the present invention;

FIG. 5 is a graphical representation of the NO γ-band emissions created by optically pumping ambient NO molecules in accordance with an embodiment of the present invention;

FIG. 6 is a schematic representation of the detector module in accordance with an embodiment of the present invention;

FIG. 7 is a graphical representation of the photodissociation spectrum of NH₄NO₃, plotting wavelength vs. intensity in accordance with an embodiment of the present invention;

FIG. 8 is a graphical representation of the photodissociation intensity-time spectrum of ammonium nitrate, plotting time vs. intensity, in accordance with an embodiment of the present invention;

FIG. 9 is a graphical representation of the photodissociation intensity-time spectrum of a propellant made of 95% nitrocellulose and 5% DNT, in accordance with an embodiment of the present invention;

FIG. 10 is a graphical representation of the absorption cross section for trinitrotoluene (TNT) in accordance with an embodiment of the present invention;

FIG. 11 is a graphical representation of the excitation of NO in the gases venting from six Winchester® 243 rifle cartridges, plotting time vs. counts in accordance with an embodiment of the present invention;

FIG. 12 is a schematic representation of an emission detector having three illumination modules in accordance with an embodiment of the present invention;

FIG. 13 is a graphical representation of the intensity profiles of the two light sources in the calibration geometry shown in FIG. 1 in accordance with an embodiment of the present invention;

FIG. 14 is a graphical representation of out-gassing material and background UV signals, plotting time vs. intensity;

FIG. 15 is a graphical representation of ambient background NO molecules, plotting time vs. intensity;

FIG. 16 is a graphical representation of the out-gassing material fluorescent signature enhanced by irradiating the surface of IMR 4350 propellant with Hg 253.7 nm radiation, plotting time vs. intensity;

FIG. 17 is a graphical representation of ambient background NO molecules, plotting time vs. intensity; and

FIG. 18 is a schematic representation of an emission detector having three illumination modules and two detector modules in accordance with an embodiment of the present invention.

### DESCRIPTION OF THE INVENTION

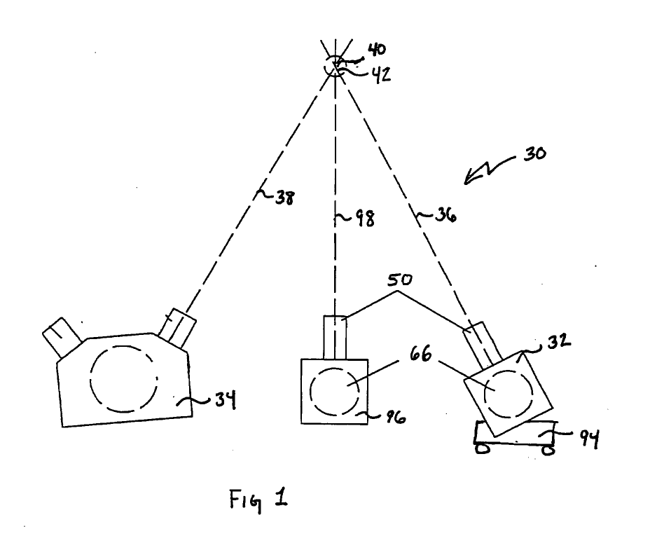

As shown in FIG. 1, the emission detector 30 of the present invention includes an illumination module 32 and a detector module 34 optically aligned with the illumination module 32. As used herein, the term “optically aligned” means that the optical path 36 of the illumination module 32 will cross the optical path 38 of the detection module 34 at a target location 40, such that the detector module 34 can detect illumination of the target location 40 provided by the illumination module 32. The target location 40 can be the location of an out-gassing material 42, such as an illegal drug or an explosive device.

In use, the illumination module 32 illuminates the out-gassing material 42 and the detector module 34 receives information from the illuminated out-gassing material 42. As used herein the term “out-gassing material” means any explosive material or illegal drug. Example explosive materials include, but are not limited to, improvised explosive devices (IEDs), trinitrotoluene (TNT), 1,3,5-trinitroperhydro-1,3,5-triazine (RDX), 1,3-dinitrato-2,2-bis (nitratomethyl)propane (PETN), ammonium nitrate (NH₄NO₃), potassium nitrate (KNO₃), C-4, nitrocellulose and nitroglycerine, which can be used in plastized form. Example illegal drugs include, but are not limited to, cocaine, PCP, and heroine. Out-gassing materials constantly out-gas an odorless characteristic propellant vapor that is undetected by the unassisted human eye. In one embodiment, the out-gassing material 42, can emit molecules of NO, NH, CH, OH, CHO, CH₂O, CH₂ and/or NO₂ in an out-gassing material plume of propellant vapor above the out-gassing material 42. Ordinary ammunition will off-gas a propellant vapor through the mechanically crimped seal between the bullet and cartridge seal. A Winchester® 243 cartridge, for example, will off-gas ˜2×10⁸ molecules of propellant vapor per second. Accordingly, when the illumination module 32 is activated, the out-gassing material 42 as well as the out-gassing propellant vapor is illuminated. Although the characteristic propellant vapor of an out-gassing material cannot be detected by the unassisted eye, the emission detector 30 of the present invention can distinguish this specific propellant vapor from background ambient gas molecules under certain specific conditions, as set forth herein.

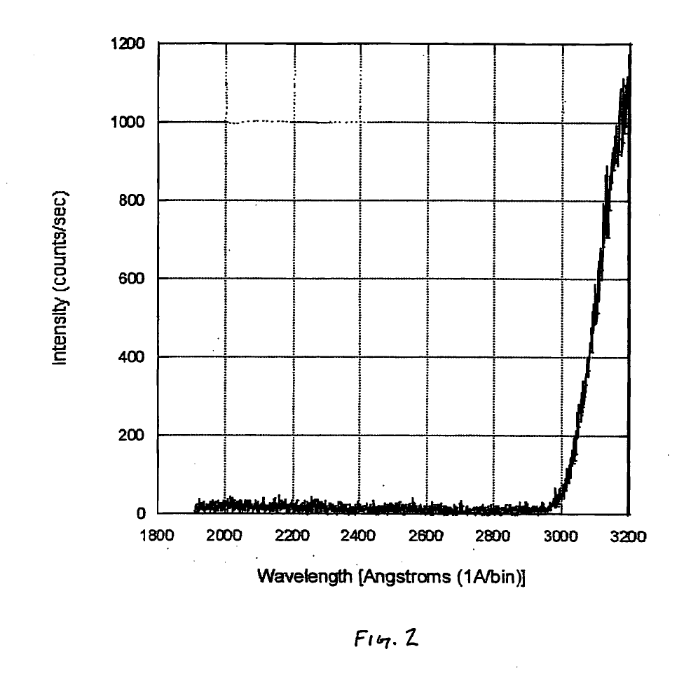

Ozone (O₃) effectively absorbs solar radiation below 310 nm. Molecular oxygen (O₂) absorbs solar radiation at shorter wavelengths of less than 250 nm. Accordingly, stratospheric ozone and molecular oxygen effectively absorb solar radiation in the range of about 200-300 nm. At ground level and elsewhere within the troposphere, usually considered to be within 13 km of the surface of the earth, there is almost no solar radiation having a wavelength of between about 200-300 nm. Accordingly, there is an atmospheric transmission range of between 185-350 nm, such as between 190-310 nm, that permits the use of ultraviolet (UV) light for the detection of the characteristic propellant vapor dispersed by an out-gassing material 42, such as an explosive or an illegal drug. This is possible because the ambient background radiation from other sources is negligible within the range of 185-310 nm, and troposphere ozone levels do not materially affect the propagation of UV light within this range. As shown in FIG. 2, the UV spectra in the troposphere at ground level does not contribute any significant spectral features in the period of from about 190-300 nm, even when sunshine is observed overhead.

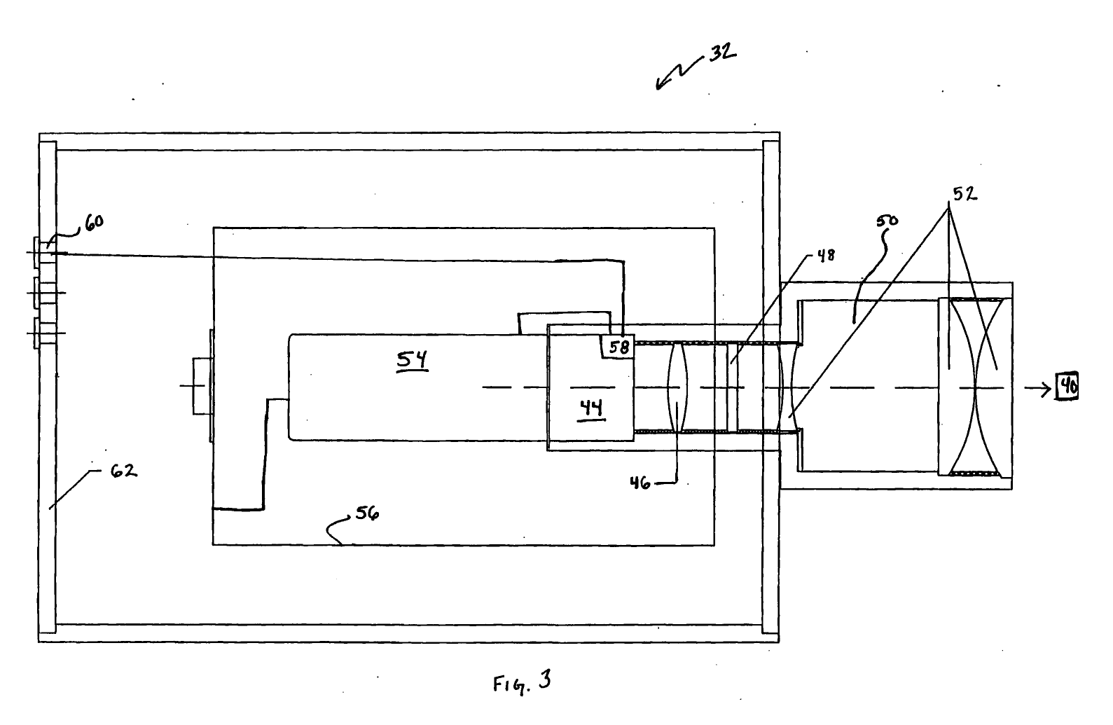

Referring to FIG. 3, the illumination module 32 of the present invention includes a light source 44, such as a flash lamp capable of outputting a flash of UV light, including vacuum ultraviolet (VUV), having a wavelength of from 109-350 nm. In one embodiment, the light source 44 can be a xenon flash lamp or a mercury flash lamp. In another embodiment, the light source 44 can be an ultraviolet xenon arc lamp or a steady-state hard ultraviolet mercury lamp. The power input to the light source 44 can be any reasonable power input, such as about 20 watts with approximately 5% converted to useful photons. As shown in FIG. 1, if the target location 40 is 300 meters away, a power input of 20 watts with 5% converted to useful photons corresponds to an illuminance of 30 watts/meter² or a flux of 3×10¹⁹ UV photons/meter². Referring again to FIG. 1, in yet another embodiment, the light source 44 can be an FX-1155 xenon arc flash lamp, commercially available from PerkinElmer, Inc. The FX-1155 xenon arc flash lamp has a MgF₂ window that transmits down to a wavelength of 105 nm. These lamps are highly stable, can operate at a flash repetition rate or greater than 300 Hz, and have a half life of greater than 1×10⁹ flashes.

Referring once again to FIG. 3, in one non-limiting embodiment, the arc of a xenon arc flash lamp can be about 3 mm long and can have a diameter of about 0.1. The arc is located at the focal point of a double biconvex lens 46 that forms a parallel beam of UV radiation. The parallel beam of UV radiation passes through an action broadband pass filter 48 which limits the wavelength to the range of from about 190-350 nm. Accordingly, the emitted flash cannot be seen by the unassisted human eye. If the target location, shown in FIG. 1, were a person, they would be completely unaware that they were being illuminated by the flash of ultraviolet light.

Referring again to FIG. 3, the parallel beam of UV radiation from the light source 44 is optically coupled through a Galilean telescope 50, and is focused onto the target location 40. The objective lenses 52 of the Galilean telescope 50 can be oriented in reverse orientation in order to reduce spherical aberration. In one embodiment, the objective lenses 52 are made of fused silica. In another embodiment, the diameter of the objective lenses 52 can be about 2 inches. However, smaller lenses are feasible but may require additional structures to compensate for the negative effects of aberrations. Larger lenses are also possible but contribute to increased size and weight of the illumination module 32.

Referring again to FIG. 3, the electrical requirements of the light source 44 are provided by a pulse transformer 54 and a power supply 56 in electrical connection therewith. A photodiode 58 can be coupled to the light source 44 to monitor the intensity of the light source 44 and to stabilize the average flash intensity. In one embodiment, the photodiode 58 has a period (τ) of about 2 nanoseconds (ns). In another embodiment, the photodiode 58 is a GigaHertz (GHz) photodiode used to generate a time-zero flash trigger. This critical signal can be used by other elements of the emission detector 30 in the support electronics and is very important for accurate radar data, as will be discussed herein. In one embodiment, the photodiode 58 can also be coupled to the pulse transformer 54. In another embodiment, the photodiode 58 can also be provided to make digital corrections to the output flash on a flash-by-flash basis. In yet another embodiment, the photodiode may include a device for generating a dispersed electromagnetic pulse for illuminating the target location 40, such as an Edmund Optics VLM laser diode module. In another embodiment, the power supply 56 of the light source 44 can be triggered by a precision digital clock coupled to an external GPS module (not shown). The GPS module can be used in the conventional manner to assist in the location and orientation of the illumination module 32. In another embodiment, a computerized memory can be housed internally within the illumination module 32 or external to the illumination module 32 and connected to feed through connectors 60 to correct the output flash.

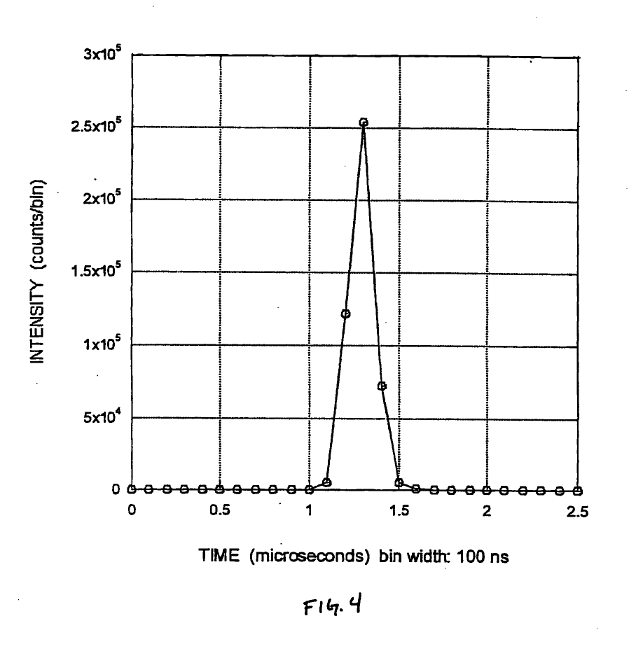

The profile of a flash of UV light output from the illumination module 32 for the purpose of illuminating an out-gassing material is shown in FIG. 4. Because the rising slope of the UV light is very steep, differential time-to-amplitude techniques that are well known in nuclear and laser physics can be used to determine the range of an out-gassing material. Accordingly, it is critical to accurately determine the firing and return pulse time of the flash of UV light. For a target distance of 300 meters, this is 2 microseconds (μs). There is an approximate 4 μs delay before the actual flash takes place and, accordingly, the true time-zero flash trigger is obtained by a high speed photodiode that observes the leading edge of the light source 44. In one embodiment, the azimuth and elevation data of the out-gassing material can be provided by a digital readout housed within a tripod or physical mount that supports the illumination module 32. A light source image size at a distance of about 300 meters is about the same height as the upper torso of a person. Accordingly, the emission detector of the present invention allows a person to be illuminated, without their knowledge, within a crowd from a substantial distance.

Referring once again to FIG. 3, the enclosure 62 can be hermetically sealed, including the elements of the Galilean telescope 50 such that immersion in water or other harsh environments does not damage the illumination module 32. The enclosure 62 can also be sealed in order to minimize electrical noise problems. Internal resistive heaters (not shown) can also be added to make the illumination module 32 operational at subzero temperatures.

Referring again to FIG. 1, the illumination module 32 can be coupled to a rotary table 66 and a remote control device (not shown) to allow the Galilean telescope 50 to be remotely positionable for focusing on a target location 40. In one embodiment, the illumination module 32 and the detector module 34 include pencil lasers (not shown) to provide alignment and pointing guidance. These lasers can have a wavelength in the visible spectrum, such as a wavelength corresponding to red or green light, or, for clandestine use, can have a wavelength corresponding to the infrared (IR). The pointing ranges of the pencil lasers can extend up to about 4,000 feet, while the illumination module 32 and the detector module 34 can have a usable range of up to about 3 km. In one embodiment, at least one of the illumination module 32 or the detector module 34 is positioned at a distance of up to about 3 km apart from the out-gassing material.

Referring again to FIG. 1, output flash of UV light from the illumination module 32 having a wavelength of from about 190 nm to about 350 nm photodissociates, photoexcites, and/or optically pumps the emitted molecules from the out-gassing material plume and excites the NO γ-bands, or other like γ-bands. Typically, NO γ-bands are found in most out-gassing material plumes, however, it is to be understood that other molecule γ-bands may also be excited. In one embodiment, the illumination module 32 photodissociates, photoexcites, and/or optically pumps the out-gassing molecules of the out-gassing material plume at a predetermined time relative to the timing of the flash of UV light.

Referring again to FIG. 1, the detector module 34 is optically aligned with the illumination detector 32 and the target location 40 to allow the photodissociated and/or photoexcited properties of the out-gassing material plume to be detected by the detector module 34. The detector module 34 is designed to obtain as many photons as possible from the out-gassing material plume. If the plume is optically thin, then the return signal decreases as 1/R² where R is the range distance. However, if the plume is optically thick, then the return signal does not behave as range dependent.

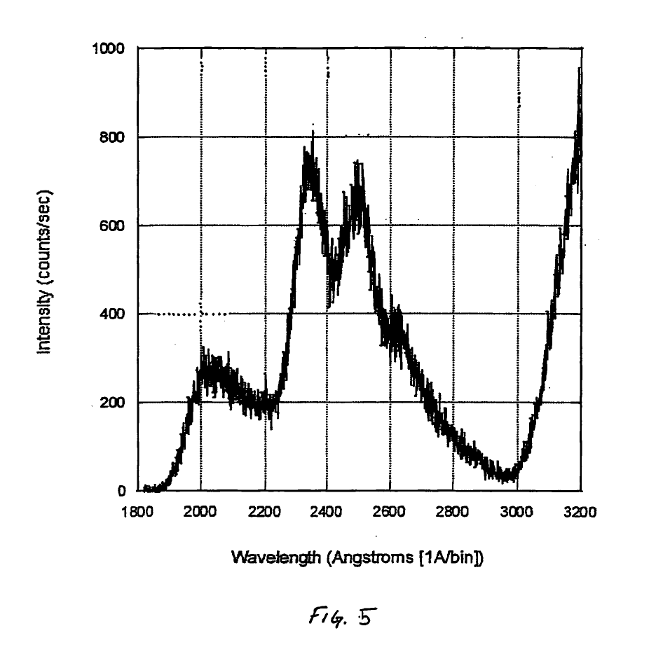

Gas molecules of NO, NH, CH, OH, CHO, CH₂O, C₂H or NO₂ can also be found in the surrounding ambient air. As shown in FIG. 5, when ambient NO molecules are optically pumped, such as by the illumination module 32 shown in FIG. 1, a very large γ-band emission fluorescence signal is observed. This result is important for several reasons. First, the signal from ambient NO molecules, which is likely to be larger in combat situations or in urban areas, has to be filtered in order to accurately determine the specific characteristic properties of the out-gassing material plume. Second, it demonstrates the effective optical pumping of NO, the major fragment produced when explosive material is photodissociated by a UV light source, at atmospheric pressure. Third, the detector module 34 of the present invention is highly sensitive to NO, and is more sensitive than other commercially available devices (e.g. chemiluminesce, ion mobility mass spectrometers, and the like) which generally have a limiting sensitivity to NO of ˜1 ppbv (parts per billion by volume). In one embodiment, the detector module 34 of the present invention is capable of detecting NO to a level of about 40 ppfv (parts per 10⁻¹⁵ by volume).

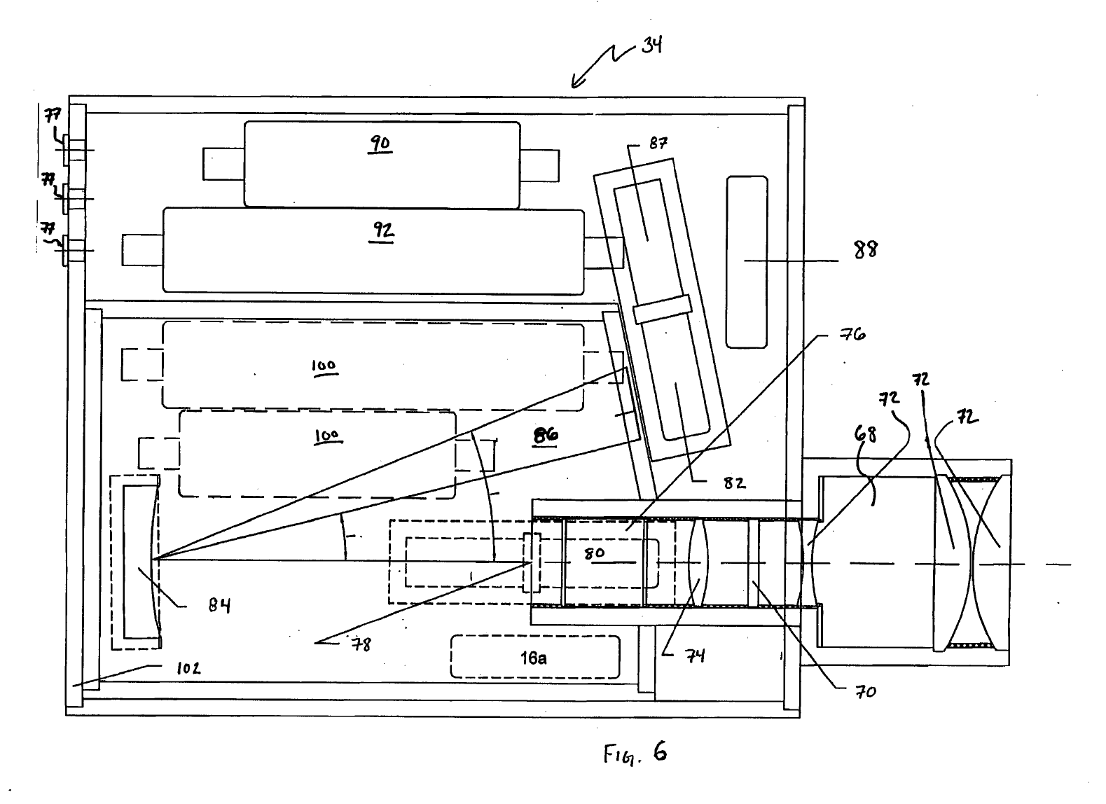

As shown in FIG. 6, in order to filter the signal from ambient gas molecules of NO, NH, CH, OH, CHO, CH₂O, C₂H or NO₂, the detector module 34 includes a molecular filter 76 that is optically matched to the ground state absorption of these ambient gas molecules. The molecular filter 76 has an output that is optically coupled to a spectrograph 82 for detecting a secondary fluorescent signature from the out-gassing material plume. The molecular filter 76 is designed to filter the signal from ambient gas molecules to reveal a secondary fluorescent signature of a specific explosive or illegal drug from the out-gassing material plume.

Referring again to FIG. 6, a Galilean telescope 68, having objective lenses 72, focuses the UV light output from the illumination module 32 onto the out-gassing molecules of the out-gassing material 42 explosive plume and into a parallel beam that passes through a broadband filter 70. The TV light is then subsequently collected by a biconvex lens 74. The biconvex lens 74 focuses the beam of UV light through a molecular filter 76 and images the beam on the entrance slit 78 of the f/2 spectrograph 82. The molecular filter 76 is a cylindrical chamber fitted on an end with fused silica windows. In one embodiment, the molecular filter 76 is filled to atmospheric pressure with a mixture of NO, N₂, synthetic air, and/or other gases to achieve the desired optical depth for the ground state absorption of ambient gas molecules in the local environment, such as the optical depth for the ground-state NO gamma band transitions. In one embodiment, the molecular filter absorbs virtually all of the ambient NO γ-band transitions terminating on the lowest ground state vibrational levels. This optical pumping by the illumination module in turn creates a strong fluorescence signal that enhances the gamma bands at longer wavelengths. The NO gamma bands created for photodissociative excitation have Doppler widths of 30 times wider of greater than the ambient signals and pass through the molecular filter with minor attenuation.

Referring once again to FIG. 6, the molecular filter 76 is configured to exhibit the line-broadening, collision-induced wavelength shifts and frequency shifts of the ambient gas molecules. This background signal of ambient gas molecules or gas molecules present in the surrounding environment, is therefore absorbed out of the primary beam of UV light, and exhibits a secondary fluorescent signature that is observable by the photomultiplier 80 in association with the spectrograph 82. In one embodiment, a dynode string electronic circuit 87, commercially available from Hamamatsu, Inc., can be coupled to the photomultiplier 80. It is important to note that the NO band emission, or other out-gassing molecule emission, produced by dissociative excitation is highly Doppler broadened, such as up to 30×, and passes through the molecular filter 76 with little or no absorption.

Referring once again to FIG. 6, the incident UV light passing through the slit 78 of the spectrograph 82 is collected by a concave grating 84 that is aberration corrected and has a matching f/number of 2. This radiation along with the emission bands emitted by the out-gassing material plume are focused on the entrance slit 78. In one embodiment, the spectrograph 82 is an f/2 spectrograph that uses a 44 mm×44 mm (900 grooves/mm) aberration corrected concave grating that matches the f/2 optics of the Galilean telescope. In another embodiment, the spectrograph 82 could be replaced by a Czerny-Turner monochromator. However, the monochromator requires curved slits for optimum performance while the concave grating device produces an excellent flat focal plane (200-350 nm) that matches the characteristics of the secondary fluorescent signature.

Referring again to FIG. 6, the dispersed photons are subsequently imaged on a flat focal plane 86 that has a very thin metal plate with slits etched through it at the wavelength position of the major gamma bands. A photomultiplier tube can be structured to collect substantially all of the NO photons and accurately preserve their collective time signature data. Other modes of operation are feasible including using newly available miniature PMT arrays so that the signals from specific wavelengths can also be collected. An HV power supply 88, preamplifier 90 having a 350 MHz bandwidth, and pulse-counting electronics 92, for powering the detector module 34 are commercially available and known in the art.

Referring again to FIG. 6, in one embodiment, two photomultiplier tubes can be used to measure the photon output fluxes from the molecular filter and the spectrograph. Because high-time resolution pulse counting technology is the preferred data handling method, the photomultiplier tubes are carefully selected for their fast rise time, such as less than 1.4 ns, and special design for photon pulse counting. In one embodiment, the photomultiplier tube is an R6353P photomultiplier tube, commercially available from Hamamatsu, Inc. The output pulses from the photomultiplier can be amplified by fast preamplifiers, having a 350 MHz bandwidth, and processed in one mode of operation by an SRS dual channel gated photon counter, having a MHz bandwidth. The sampling window for this system can be as small as 10 ns and thus provides excellent support for the time-of-flight information needed to obtain accurate range information. This system has a dynamic range of more than eight orders of magnitude and is completely compatible with laptop computer operation in the field.

As shown in FIG. 6, the detector module 34 can have two stacked internal platforms. The electronics 100 and the photomultiplier tube 80 are drawn with dashed lines, as in one embodiment, these components may be located on the lower platform. The electronics 100, including a pulse amplifier or discriminators, has a detection bandwidth approaching 300 MHz with near microvolt sensitivity. Accordingly, lapped joints with copper foil inserts are used in the detector module 34. In critical areas, choke lapped joints, like those used in microwave engineering, can also be used. The power inputs and other control signals may be coupled into the detector module 34 through hermetically sealed EMI filters. The detector module 34 can be physically sealed in housing 102 to prevent stray electromagnetic radiation. All of the power lines, control signals and digital output data use may use standard BNC fittings 77. The BNC fittings can be coupled to an extensive external electronics system, such as via 50Ω coaxial cable.

In order to observe the fluorescence created by the flash at a particular point, the detector module must view the overlap region at the same time the flash illuminates the target location. Referring once again to FIG. 6, the Galilean telescope 68 may be aberration-corrected in order to ensure that the UV flash and slit images can be properly matched. In another embodiment, the Galilean telescope 68 can be automated like a conventional camera. In one embodiment, a master time clock of the detector module 34 (not shown) is synchronously started by the photodiode trigger 58 of the illumination module 32, such that the time-of-flight of the flash of UV light is accurately measured. The performance target is a range resolution, ΔR, of about 30 cm at a range distance of 100 meters. As shown in FIG. 4, in view of the steepness of the leading edge of the flash pulse, this requirement can be achieved readily by the present invention. Azimuth and elevation angles can be determined through conventional mechanical and optical means.

Data collected by the detector module 34 can be processed in a variety of ways including using Ortec Multichannel Scalars or a Stanford Research Systems Model SR400 dual channel gated photon counter. Miniature versions of these technologies are anticipated herein that may be employed within the emission detector 30 of the present invention. Software support for this instrumentation is also anticipated herein to analyze the molecular filter 76 data. The software support may also contain an explosive time-signature library for identifying the unique secondary fluorescent signature. In another embodiment, a second version of the digital electronics uses multi-channel scalar (MCS) technology. Although the time resolution is longer, such as on the order of 100 ns, and the bandwidth narrower, such as on the order of 150 MHz, it has the major advantage of collecting the entire time signature for each individual flash and then coherently summing these data over many cycles in order to reduce the fluctuation statistics.

Referring once again to FIG. 5, no comparable natural background like that shown for NO in FIG. 5, is detected for the dissociative fragments (e.g., CH, C₂H, etc.) that are excited by the photodissociation of explosives or illegal drugs such as cocaine and heroin. Each secondary fluorescent signature is a “fingerprint” photodissociative fragment which radiates in the atmospheric window of the flash of UV light having a wavelength of between 190-310 nm.

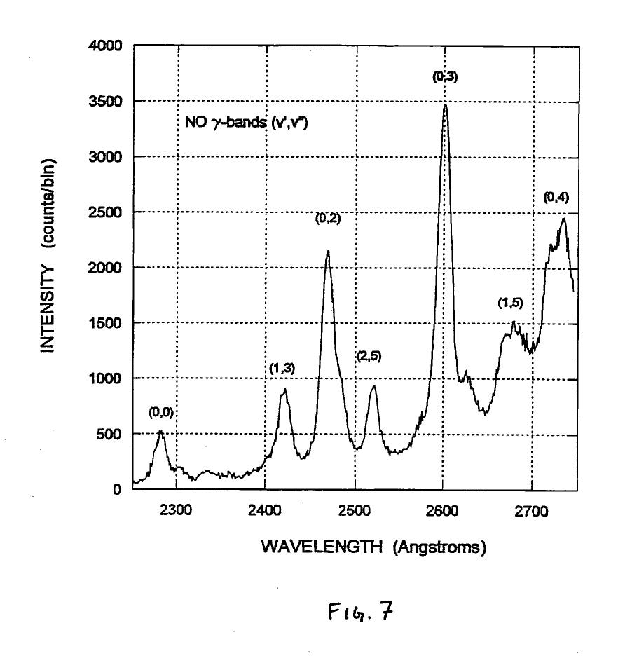

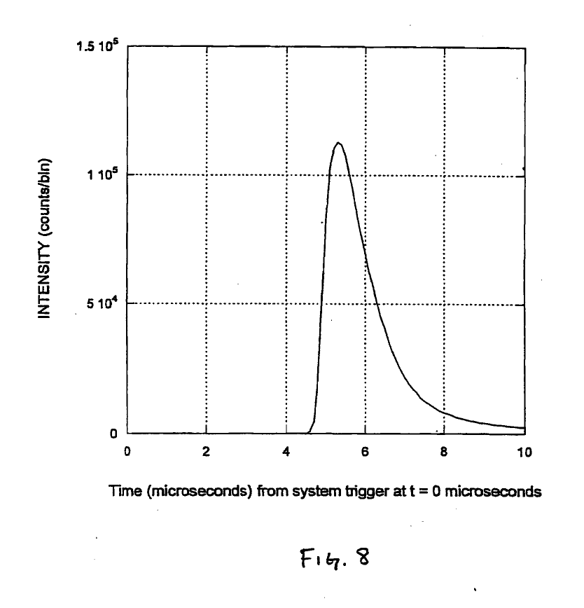

As shown in FIG. 7, the photodissociation spectrum of NH₄NO₃ reveals that the “fingerprint” gamma band system of nitric oxide is very prominent in major explosives, even for a small sample, such as 28 grams. FIG. 8 illustrates the intensity time-signature of the 330 nm emission from the NH hydrazine radical produced by the photodissociation of ammonium nitrate. FIG. 9 illustrates the intensity time-signature of a 413 nm emission from the CH radical produced by the photodissociation of a propellant made of 95% nitrocellulose and 5% DNT. The prompt peak near 4.6 μs is coincident with the absorption of the flash radiation directly.

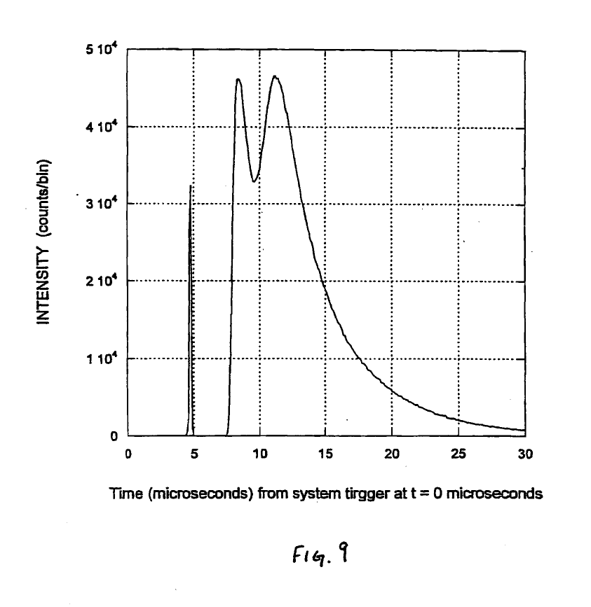

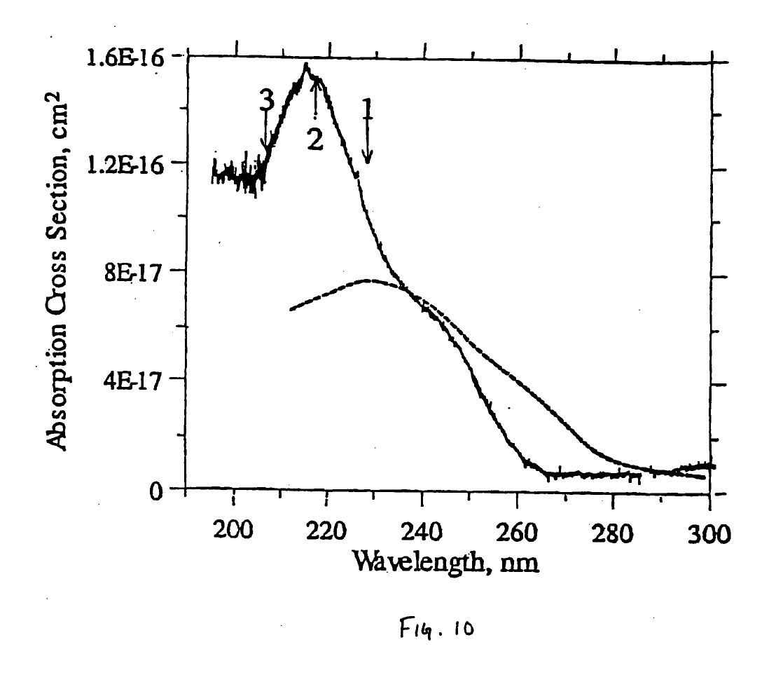

As shown in FIG. 10, the absorption cross section for trinitrotoluene (TNT) and the excitation of the upper state of the NO γ-bands [A²Σ⁺(v′=0, 1, 2)←X²Π(v″=0)] is noted. As shown, this band system, and other fragment molecules (NH, CH, CH₂O and OH) and their time signatures are unique to each out-gassing material.

As shown in FIG. 11, the xenon flash is on the order of about 200 ns at the base line. All of the flash of UV light is absorbed by the out-gassing material within this time interval and, accordingly, there is no delayed input of chemical energy. There are also no detectable noise pulses in the baseline. This is due to the fact that the data window is only 100 ns, and the probability of observing or counting one of the noise pulses, such as dark currents having a counting rate of about 10 counts/second, is statistically insignificant. FIG. 11 shows the excitation of NO in the gases venting from six Winchester® 243 rifle cartridges.

As shown in FIG. 11, the NO signal in ambient air at atmospheric pressure is clearly broader then the intrinsic flash, as shown in FIG. 4, and that it has an extensive tail. Only the first two points of FIG. 11 are due to immediate optical excitation as the result of the absorption of the flash photons. The observed delayed radiative signal is the result of complex excited chemistry. There is no photochemical model for the major delayed CH peak observed 1.8 μs after the “prompt” emission feature. The implication is that some CH radicals are excited in the actual initial photofragmentation process and thus marked by the time signature of the xenon flash itself.

Referring again to FIG. 1, in one embodiment, the illumination module 32 and the detector module 34 are each designed to run on portable batteries and occupy a volume of less than one cubic foot. The batteries may be recharged by a small solar cell panel. Data from each of the illumination module and the detector module may be telemetered to a central command center where data from several sensors could be used to track terrorists entering the screened zone. The telemetry requirements may be minimal and would not require any support even modestly approaching a contemporary cell phone.

In another embodiment, the illumination module 32 and the detector module 34 are each designed to weigh less than about 15 pounds. At least a portion of the emission detector 30 is structured to be positioned on a housing of a drone 94. Accordingly, in one embodiment, the emission detector 30 can be used in association with drones, low flying manned aircraft, or tethered balloons, in addition to ground applications. As used herein, a “drone” includes any robotic or remotely controlled unmanned vehicle. In this embodiment, the emission detector 30 of the present invention may be used to locate munitions and rocket caches by detecting their characteristic out-gassing propellant vapor. Accordingly, munitions caches stored in bunkers or buried underground could be discovered by a ground or drone survey team. Further, a vehicle being driven by an armed person has a marker that may be used by the police from a safe distance, such as from about 30 feet, to determine whether to approach the car or to call for additional help. In another embodiment, the emission detector can be housed on a simple robot land rover and used as a field mine detector.

In addition, the emission detector 30 of the present invention can be functional in both daytime and nighttime conditions, and is not optically nor acoustically detectable. Furthermore, when coupled with additional software, the emission detector of the present invention can function as a 3-dimensional UV imager, and can map the local environment and determine the precise location of any backscattered UV fluorescence source and access its significance.

Referring again to FIG. 1, a second illuminator module 96 can be optically coupled along optical pathway 98 to the target location 40. In this embodiment, one illuminator module 32 photodissociates the out-gassing molecules in the free-air plume of the out-gassing material 42 and the second illuminator module 96 monitors the fluorescent signal from the background gas some distance away from the location of the out-gassing material 42. In one embodiment, the illuminator modules 32 can be used as a single channel device, in which sensitivity in this mode of operation is determined by the Poisson statistics of the observed signal and is ultimately limited by the magnitude of the background noise level of the second illuminator module 96.

In another embodiment, enhanced sensitivity can be obtained by operating in a differential mode, i.e., flash by flash. Furthermore, the data from the monitoring photodiodes can be used in two ways to enhance the performance of the invention. The first approach uses the signal from the high speed diodes to actively regulate the HW power supplies servicing the light source in an active feedback system designed to reduce the effects of drift minor fluctuations, etc. The second approach uses signals from the photodiodes for each light source to generate an error signal that software modifies the digital data stored in real time. The correction is on a flash-by-flash basis.

If it is necessary to reduce the noise signal from ambient gas molecules, i.e., NO, in a combat environment or in urban air contaminated by industry and/or cars, this reduction can be accomplished by using an optically thick molecular filter and a well-proven, double pass spectrometer design. The UV light source can be structured to operate in a pulsed mode, and the photon data can be processed real time using ultra-high speed digital electronics. The emission detector can be programmed as a simple warning device or its data can be processed by a laptop computer that would allow 3-D imaging of the battlefield in real time. The unique identification of the explosive material by comparison with a time-signature data base can be determined within a few seconds. Accordingly, temporal characteristics of the photodissociation process, such as the secondary fluorescent signature of an out-gassing material, not only warns of the presence of an explosive or drug, but can also be used to determine the identity of the explosive and drug.

In another embodiment of the invention, the effects of random noise may be reduced further by two methods: (1) the intensity measurements from the ultra fast photodiodes that directly monitor the flash lamps and determine the τ=0 sec. time, can be used in a closed feedback loop that adjusts the high voltage to the lamps until their intensities match. This method is widely used in power supplies to regulate the output voltage. It averages many flashes and would generally have a bandwidth response of 10 Hz or so. The second method is more sophisticated. It consists of comparing the photodiode signal for each flash, generating an error signal which is used by the software to correct the digital data entries in real time and for each flash cycle. Thus, this approach does not physically change the lamps but rather takes note of their meandering behavior and directly corrects the data flash by flash. No prior art discusses such advanced signal processing.

In one embodiment, the emission detector can be used to track the location of a moving out-gassing material, such as a sniper, by following the NO trail created by the shock wave and surface chemistry of a high velocity bullet. Plume studies have determined that the excited chemistry plume of a bullet can last for minutes. This tracking capability has obvious combat applications, but is equally useful in urban and city settings for SWAT team incidents. In another embodiment, the emission detector is completely computer data processing software compatible and can be used to create images of the battlefield in front of the bomb detector. In yet another embodiment, the emission detector of the present invention can be used as part of a surveillance technique called “Chemical Tagging”. In this embodiment, various objects including money and packages, are “marked” with a suitable chemical fingerprint that can be detected by the emission detector.

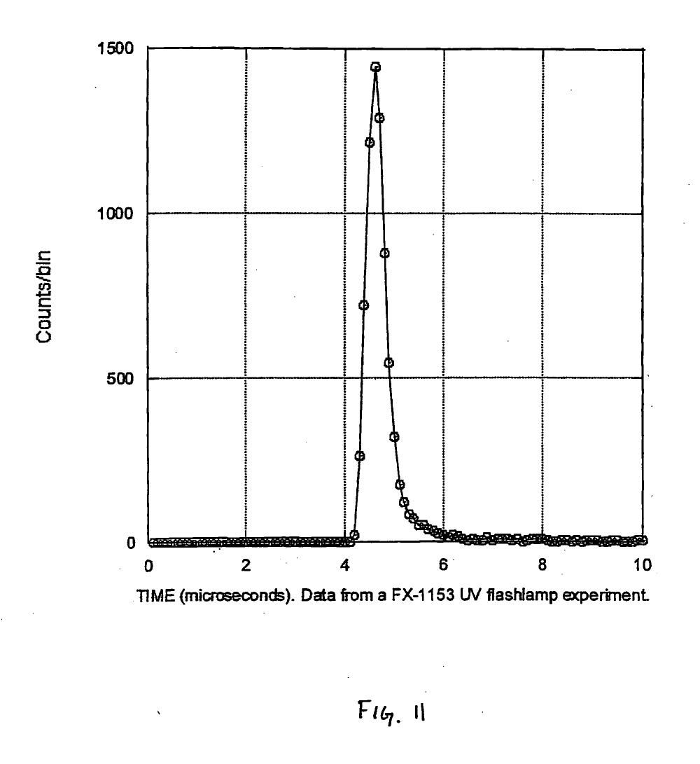

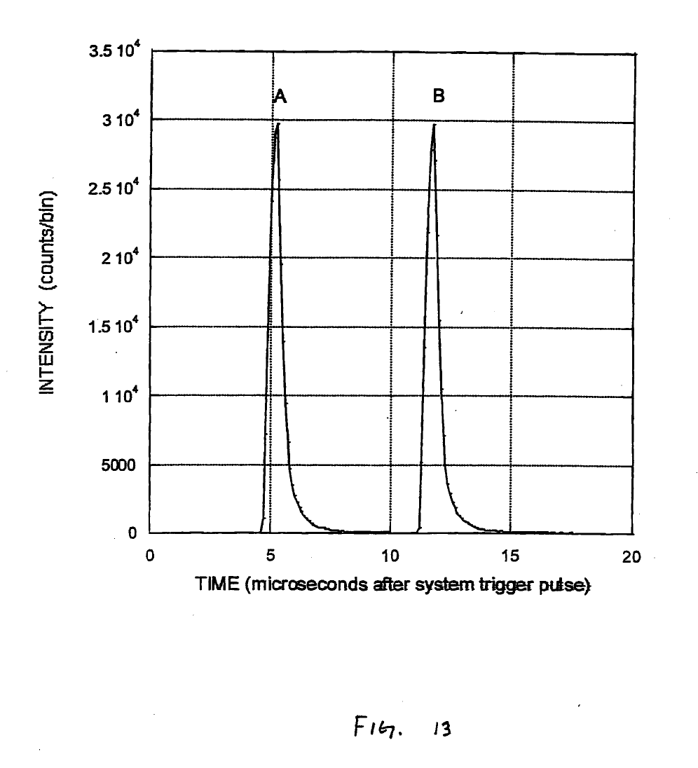

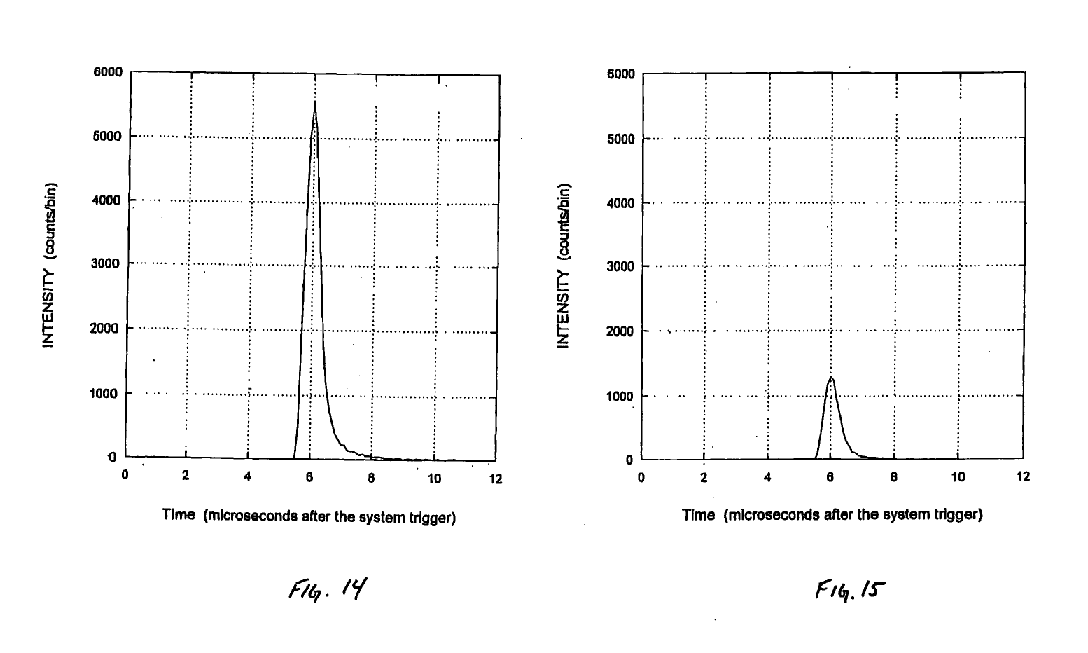

In another embodiment of the present invention, shown in FIG. 12, the emission detector includes a first UV light source 106, a second UV light source 108, and a third UV light source 110. In this embodiment, at least one of the light sources 106, 108 or 110 may be mounted on a first moveable structure 112, such as a drone (for example, a wheeled or tracked cart), while the other units could be mounted on a second moveable structure 114, such as a vehicle. The third UV light source 110 can induce surface catalytic emissions from the explosive. Previous laboratory experiments and theoretical modeling suggest that the enhancement could be as much as a factor of 10⁶. The preliminary results shown in FIGS. 14 and 15 indicate that this effect does in fact occur.

Referring again to FIG. 12, the second light source 108 aligned along axis-B measures the NO background signal from the local environment while the first light source 106 aligned along axis-A probes the out-gassing material 120 and excites the photofragments created by the UV flash radiation. The detector module 111 can be optically aligned with the illumination module 106 and with the illumination module 108. The detector module 111 can include a molecular filter that is optically matched to the ground state absorption of ambient gas molecules and a spectrograph optically coupled to the output of the molecular filter for detecting a secondary fluorescent signature from the out-gassing material 120.

Referring again to FIG. 12, the present invention may utilize photon pulse counting technology. The detection of a weak explosive signal is primarily limited by the bandwidth of the electronics, such as about 350 MHz, and the signal-to-noise ratio, which can be determined by Poisson statistics. In one embodiment, the emission detector may operate in the differential mode in order to minimize background noise interference. In one embodiment, the detector module 111 can include a photon counter (not shown), such as an SR400 dual channel gated photon counter, can be used to define two specific gates separated by about 5 μs. This gated approach provides a high degree of immunity to continuous, low-level random background noise. The paired gates can also be scanned synchronously so that the invention scans in range (r) and can also provide azimuth and elevation data if mounted on a suitable rotary table. If the invention is provided with a GPS transceiver, the location of the out-gassing structure 120 can be identified in true geodesic coordinates altitude (z), latitude (Θ), and longitude (Φ). In another embodiment, these coordinates can be transmitted directly to a command center. In another embodiment, the single signal mode the statistical error in the net explosive signal, S, can be the difference between the composite signal determined from axis-A (explosive signature plus background) and a separate measurement of the background determined from axis-B. The new statistical error is the sum of the Poisson statistic simple added (no cancellation effects) or (A−B)^{1/2}+(B)^{1/2}. In the preferred embodiment, the composite signal (A+B) and the background level B are measured simultaneously and subtracted in real time by the SR400 dual channel gated photon counter. The effective uncertainty is now reduced to the quadrature sum: [(A−B)²+(B)²]^{1/2} which is about 50% smaller (or better).

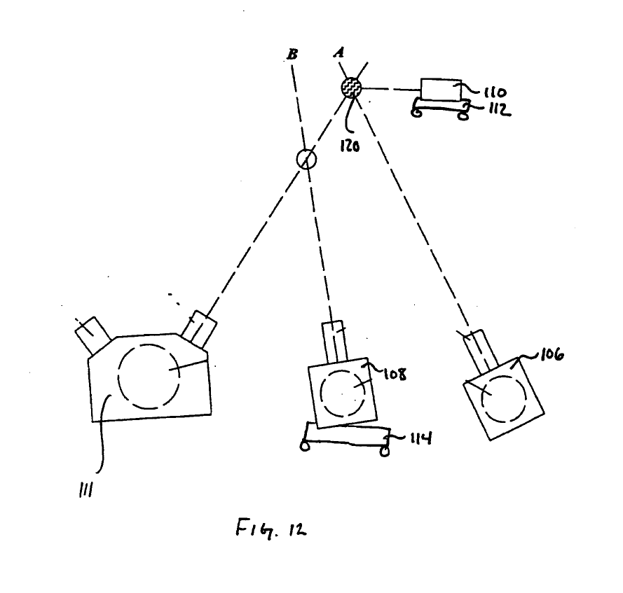

FIG. 13 shows the intensity profiles of the two light sources in the calibration geometry shown in FIG. 1. As shown in FIG. 13, peak A is produced by the illumination module 106 of FIG. 12 and peak B is produced by the illumination module 108 of FIG. 12 that is triggered by a 6.5 μs delay. Accordingly, the light sources are triggered independently with a time delay of about 6.5 μs. The data are processed by a dual channel gated photon counter operated in its differential counting mode. The intensity of the lamps can be made equal by minor adjustments to their high-voltage supplies.

FIGS. 14-15 illustrate the plot of the intensity-time signature of 248 nm emission from the NO(A->X) (0,0) γ-band excited by the photofragmentation of IMR 4350 propellant. The peaks shown in FIG. 14 are from the excited out-gassing material plume produced by illumination module 106 and observed by detector module 111, each shown in FIG. 12. The background signal from naturally occurring ambient NO is excited by illumination module 108 and also observed by detector module 111, also shown in FIG. 12. The absence of the “prompt” signal at 4.6 microseconds and the appearance of a delayed peak (˜1 microsecond) are comparatively short-lived. The primary channel A and B data referred to in FIG. 10 are shown in the non-differential mode so that the excellent S/N noise ratio can be seen. The ambient NO was at the 50 pptv level, determined by a PLC 860/CLD 88YP NO/NO_{X} high sensitivity analyzer manufactured by Eco Physics. This data suggests that the emission detector of the present invention can detect explosive molecules in the free-air plume at a level near one femto (10⁻¹⁵) parts by volume at atmospheric pressure.

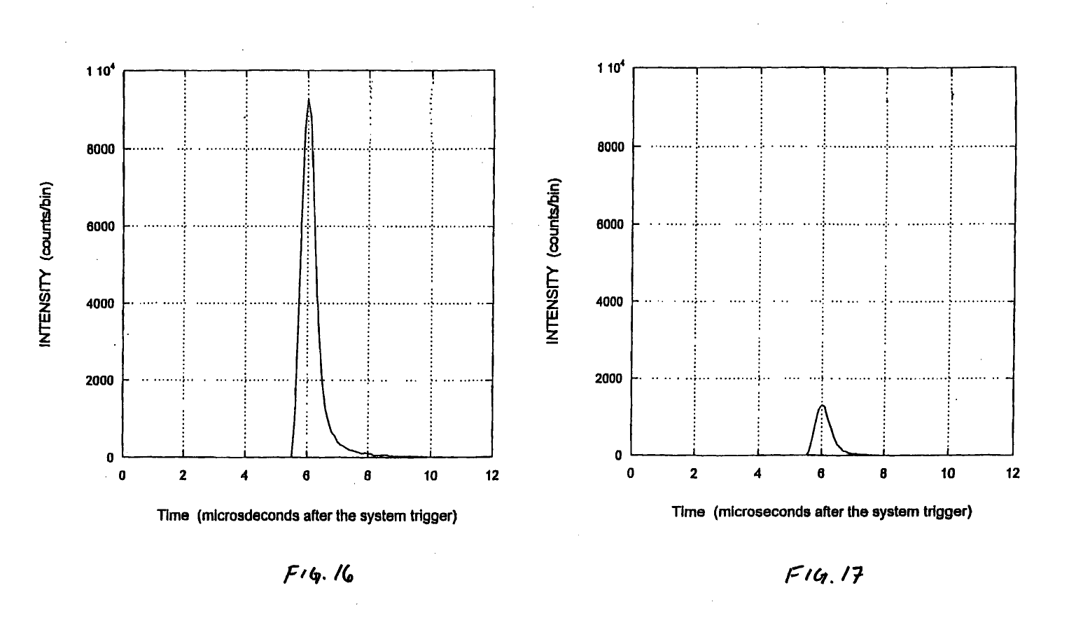

As shown in FIGS. 16-17, the remote bomb detector has a third mode of operation. Explosive vapors deposited on surfaces by design, a characteristic feature of all aromatic explosives, can be catalytically decomposed into NO, CH, OH and NH radicals by an independent UV radiation surface focused on the ground just above the buried landmine or IED. Unlike the vapor pressure of the explosive gases in the air that have a profound temperature dependence, such as virtually disappearing at temperatures of 0° C., the catalytic process is nearly temperature independent and thus is completely operational in winter combat scenarios. The enhanced NO emission associated with the surface absorption of Hg λ253 nm radiation is shown in FIGS. 16-17.

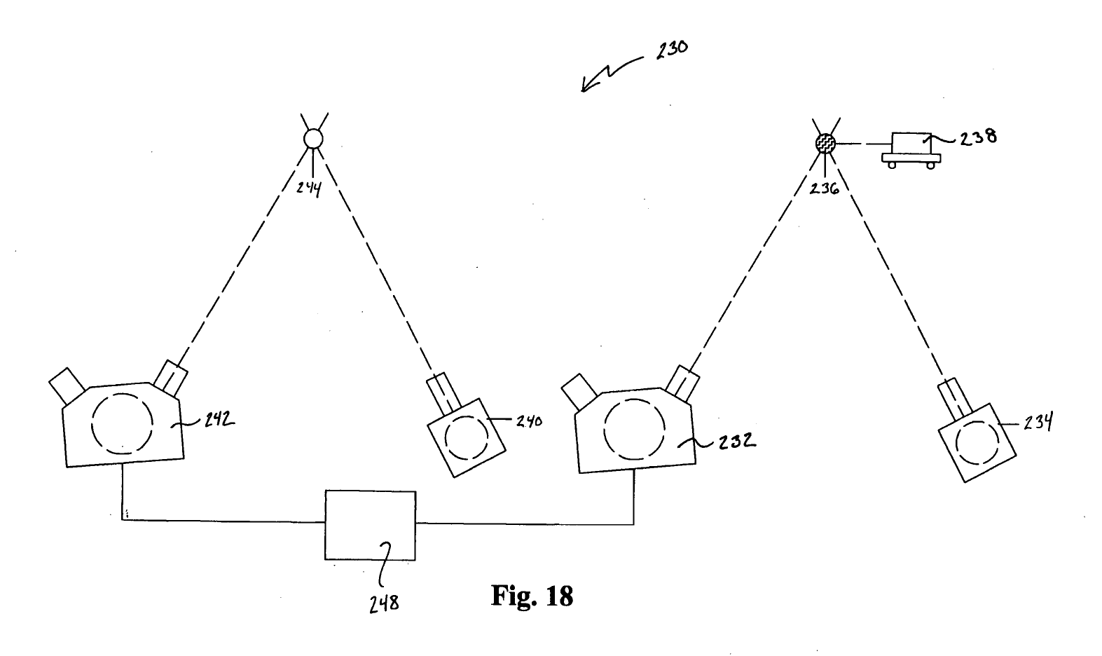

As shown in FIG. 18, in another embodiment of the present invention, an emission detector 230 of the present invention includes a first illumination module 234 for illuminating an out-gassing material 236, and first detector module 232 optically coupled to the first illumination module 234. As discussed herein, a second illumination module 238, for monitoring ambient gas molecules, such as but not limited to NO, may also be coupled to the first detector module 232. In one embodiment, the second illumination module 238 may be positioned in a localized proximity to the out-gassing material 236, such as within 3 km. A third illumination module 240, for monitoring ambient gas molecules 244, may be optically coupled to a second detector module 242. In one non-limiting embodiment, the third illumination module 240 and the second detector module 242 can be positioned in a remote proximity to the out-gassing material 236, such as greater than 3 km. In this embodiment, the second illumination module 238 and the first detector module 232 can provide a localized determination of the ground state of local ambient gas molecules and the third illumination module 240 and the second detector module 242 can provide a remote determination of the ground state of remote ambient gas molecules. The first detector module 232 and the second detector module 242 can be coupled in data communication to allow data to be transferred and/or shared. In one embodiment, the first detector module 232 and the second detector module 242 can be electrically connected to a computer or electronic data storage device 248 for data synthesis and/or storage. Accordingly, the ground state of local ambient gas molecules can be compared against the ground state of remote ambient gas molecules to determine the proper background noise in order to properly observe the secondary fluorescent signature of an out-gassing material. This embodiment can be advantageous for environments in which a large amount of out-gassing material is present in the vicinity of the first detector module 232, such as in proximity to an exploded bomb. In a broad aspect, in this embodiment of the invention an illumination module and a detector module (e.g., first unit) are used to determine the general level of one or more materials of interest in the atmosphere in the general area being searched. This information is used to establish a “baseline” amount of the materials in the atmosphere. Another illumination module and detector module (unit 2) are used to search for one or more selected materials as described above. The information from the second unit is compared to the information from the first unit and a reading above the baseline level can indicate the presence of a bomb or other explosive device.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. An emission detector comprising:
an illumination module, comprising a light source for outputting a flash of ultraviolet light having a wavelength of from 190 nm to 350 nm, the output flash illuminating an out-gassing material; and
a detector module, optically aligned with the illumination module, the detector module comprising a spectrograph for detecting a secondary fluorescent signature from the out-gassing material.

2. The emission detector of claim 1, wherein the detector module further comprises a molecular filter that is optically matched to the ground state absorption of ambient gas molecules, the molecular filter having an output, wherein the spectrograph is optically coupled to the output of the molecular filter.

3. The emission detector of claim 1, wherein the illumination module comprises a xenon flash lamp or a mercury lamp.

4. The emission detector of claim 3, wherein the illumination module comprises an ultraviolet xenon arc lamp or a steady-state hard ultraviolet mercury lamp.

5. The emission detector of claim 1, wherein the illumination module further comprises a Galilean telescope in optical transmission with the light source.

6. The emission detector of claim 5, wherein the Galilean telescope is remotely positionable.

7. The emission detector of claim 1, wherein the illumination module further comprises a GHz photodiode which generates a zero-time flash trigger coupled to a pulse transformer.

8. The emission detector of claim 1, wherein the illumination module further comprises a digital precision clock coupled to an external GPS module.

9. The emission detector of claim 1, further comprising a second illumination module comprising a light source for outputting a flash of ultraviolet light having a wavelength of from 190 nm to 350 nm, optically coupled to the out-gassing material, wherein the first illumination module and the second illumination module have matched intensities.

10. The emission detector of claim 1, further comprising a second illumination module comprising a light source for outputting a flash of ultraviolet light having a wavelength of from 190 nm to 350 nm, optically coupled to ambient gas molecules.

11. The emission detector of claim 1, wherein the illuminator module photodissociates, photoexcites, and/or optically pumps the out-gassing material plume.

12. The emission detector of claim 11, wherein the illuminator module photodissociates, photoexcites, and/or optically pumps the out-gassing material plume at a predetermined time relative to the timing of the flash of ultraviolet light.

13. The emission detector of claim 1, wherein the out-gassing material plume comprises molecules of at least one of NO, NH, CH, OH, CHO, CH₂O, C₂H or NO₂.

14. The emission detector of claim 1, wherein the ambient gas molecules are at least one of NO, NH, CH, OH, CHO, CH₂O, C₂H or NO₂.

15. The emission detector of claim 14, wherein the molecular filter comprises a chamber filed to atmospheric pressure with NO, NH, CH, OH, CHO, CH₂O, C₂H or NO₂, synthetic air, or other gases to yield an optical depth of a ground-state gamma-band from the ambient gas molecules.

16. The emission detector of claim 1, further comprising a photomultiplier in optical communication with the spectrograph.

17. The emission detector of claim 1, wherein the spectrograph includes at least one of a 44 mm×44 mm aberration corrected concave grating or a Czemy-Turner monochromator.

18. The emission detector of claim 1, wherein the detector module further comprises at least one pulse amplifier or discriminator connected to the photomultiplier to detect optical bandwidths of up to about 300 MHz.

19. The emission detector of claim 1, further comprising a Galilean telescope for receiving optical properties of the illuminated out-gassing material.

20. The emission detector of claim 19, wherein the Galilean telescope is remotely positionable.

21. The emission detector of claim 1, wherein at least one of the illumination module or the detector module are positioned at a distance of up to 3 km apart from the out-gassing material.

22. The emission detector of claim 1, wherein the out-gassing material is an explosive or an illegal drug.

23. The emission detector of claim 22, wherein the out-gassing material is at least one of RDX, PETN, NH₄NO₃, KNO₃, nitrocellulose or nitroglycerine.

24. A drone, comprising:
a housing;
means for remotely moving the housing; and
an emission detector, at least partially positioned on the housing, the emission detector comprising:
an illumination module, comprising a light source for outputting a flash of ultraviolet light having a wavelength of from 190 nm to 350 nm, the output flash illuminating an out-gassing material; and
a detector module, optically aligned with the illumination module, the detector module comprising a spectrograph for detecting a secondary fluorescent signature from the out-gassing material.

25. The drone of claim 24, wherein the detector module further comprises a molecular filter that is optically matched to the ground state absorption of ambient gas molecules, the molecular filter having an output, wherein the spectrograph is optically coupled to the output of the molecular filter.

26. The drone of claim 24, further comprising a second illumination module comprising a light source for outputting a flash of ultraviolet light having a wavelength of from 190 nm to 350 nm, optically coupled to the out-gassing material.

27. The drone of claim 24, further comprising a second illumination module, the second illumination module comprising a light source for outputting a flash of ultraviolet light having a wavelength of from 190 nm to 350 nm, optically coupled to ambient gas molecules.

28. The drone of claim 24, wherein the illuminator module photodissociates, photoexcites, and/or optically pumps the out-gassing material plume at a predetermined time relative to the timing of the flash of ultraviolet light.

29. The drone of claim 24, wherein the out-gassing material plume comprises molecules of at least one of NO, NH, CH, OH, CHO, CH₂O, C₂H or NO₂.

30. The drone of claim 24, wherein the ambient gas molecules are at least one of NO, NH, CH, OH, CHO, CH₂O, C₂H or NO₂.

31. The drone of claim 24, wherein the molecular filter comprises a chamber filed to atmospheric pressure with NO, NH, CH, OH, CHO, CH₂O, C₂H or NO₂, synthetic air, or other gases to yield an optical depth of a ground-state gamma-band from the ambient gas molecules.

32. The drone of claim 24, wherein at least one of the illumination module or the detector module is positioned at a distance of up to about 3 km apart from the out-gassing material.

33. The drone of claim 24, wherein the out-gassing material is an explosive or an illegal drug.

34. The drone of claim 33, wherein the out-gassing material is at least one of RDX, PETN, NH₄NO₃, KNO₃, nitrocellulose or nitroglycerine.

35. A method of detecting an out-gassing substance, comprising the steps of:
outputting a flash of ultraviolet light having a wavelength of from 190 nm to 350 nm to illuminate an out-gassing material, the out-gassing material emitting an out-gassing material plume;
detecting molecular properties of the out-gassing material plume;
filtering the ground-state absorption of ambient gas molecules with a molecular filter; and
detecting a secondary fluorescent signature from the out-gassing material plume through the molecular filter.

36. The method of claim 35, wherein the out-gassing substance is an explosive or an illegal drug.

37. The method of claim 35, wherein the out-gassing material is at least one of RDX, PETN, NH₄NO₃, KNO₃, nitrocellulose or nitroglycerine.

38. An emission detector comprising:
a first illumination module, comprising a light source for outputting a flash of ultraviolet light having a wavelength of from 190 nm to 350 nm, the output flash illuminating an out-gassing material;
a first detector module, optically aligned with the illumination module, the detector module comprising a spectrograph for detecting a secondary fluorescent signature from the out-gassing material;
a second illumination module, comprising a light source for outputting a flash of ultraviolet light having a wavelength of from 190 nm to 350 nm, the output flash illuminating ambient gas molecules; and
a second detector module, optically aligned with the illumination module, the detector module comprising a spectrograph for detecting a secondary fluorescent signature of the ambient gas molecules.

39. The emission detector of claim 38, wherein the first detector module and the second detector module are in data communication.

40. The emission detector of claim 38, wherein at least one of the first detector module or the second detector module comprises a molecular filter that is optically matched to the ground state absorption of ambient gas molecules, wherein the spectrograph is optically coupled to an output of the molecular filter.

41. The emission detector of claim 38, wherein at least one of the second illumination module or the second detector module is positioned at a distance of greater than 3 km from the out-gassing material.
